(19) United States
(12) Patent Application Publication
(10) Pub. No.: US 2009/0195303 A1
(43) Pub. Date: Aug. 6, 2009

(54) Method of Reducing Common Mode Current Noise in Power Conversion Applications

(75) Inventor: William J. Bowhers, Wayland, MA (US)

Correspondence Address: WILLIAM JOSEPH BOWHERS, 3 HILLSIDE AVE., AMESBURY, MA, 01913, US

(73) Assignee: William Joseph Bowhers, Wayland, MA (US)

(21) Appl. No.: 12/025,071

(22) Filed: Feb. 4, 2008

(51) Int. Cl. H04B 1/10

(52) U.S. Cl. 327/551

(57) ABSTRACT

A transformer and filter circuit for reducing common mode noise current in isolated power conversion circuits, comprising a series connection of: a first transformer having an N:1 turns ratio, a common mode current filter, and a second transformer having a 1:M turns ratio. The overall effect being a transformer with N:M turns ratio and with low capacitive coupling from the primary N turns to the secondary M turns thus providing a high impedance to common mode currents crossing the isolation. The series connection of two transformers allows one to be bridged with additional common mode filter components without significant reduction in isolation impedance.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

U.S. C1. 318/254, 671, 327/552, 336/200, 223, 232, 363/39, 40, 47, 48

### REFERENCES

### U.S. Patent Documents

| | | | |
|---|---|---|---|
| 5,990,776 | November 1999 | Jitaru | 336/200 |
| 6,208,098 B1 | March 2001 | Kume et al. | 318/254 |
| 6,377,479 B1 | April 2002 | Ayano et al. | 363/40 |
| 6,490,181 B1 | December 2002 | Liu et al. | 363/40 |
| 6,583,682 B1 | June 2003 | Dubhashi et al. | 333/12 |
| 6,636,107 B2 | October 2003 | Pelly | 327/552 |
| 6,788,558 B2 | September 2004 | Pelly | 363/40 |
| 6,794,929 B2 | September 2004 | Pelly | 327/552 |
| 6,842,069 B2 | January 2005 | Takahashi et al. | 327/552 |
| 6,879,500 B2 | April 2005 | Liu et al. | 363/40 |
| 6,898,092 B2 | May 2005 | Briere et al. | 363/39 |
| 6,927,665 B2 | August 2005 | Nakatsu et al. | 336/200 |
| 6,980,074 B1 | December 2005 | Jitaru | 336/200 |
| 7,038,899 B2 | May 2006 | Hsu et al. | 361/118 |
| 7,078,988 B2 | July 2006 | Suzuki et al. | 333/181 |
| 7,292,126 B2 | November 2007 | So | 336/200 |

### U.S. Patent Application Publications

| | | | |
|---|---|---|---|
| 2001/0045863 A1 | November 2001 | Pelly | 327/552 |
| 2003/0210563 A1 | November 2003 | Takahashi et al. | 363/44 |
| 2004/0027224 A1 | February 2004 | Giandalia et al. | 336/200 |
| 2004/0041534 A1 | March 2004 | Takahashi | 318/671 |
| 2004/0240236 A1 | December 2004 | Lanni | 363/39 |
| 2005/0242916 A1 | November 2005 | So | 336/200 |
| 2006/0109072 A1 | May 2006 | Giandalia et al. | 336/200 |
| 2007/0127275 A1 | June 2007 | Chuang et al. | 363/39 |

### Other Publications:

### Tyco FLTR75VO5 Filter Module Data Sheet

### Synqor Application Note 00-08-02, “EMI Characteristics.”

T. Curatolo, S. Cogger, “Enhancing a power supply to ensure EMI compliance,” EDN, Feb. 17, 2005.

### (1) FIELD OF THE INVENTION

This invention relates to an electromagnetic interference (EMI) suppression technique and, more particularly, to common mode current noise reduction circuit to be applied to isolated power conversion circuits. Most generally, these devices include DC-to-DC, AC-to-DC, DC-to-AC and AC-to-AC converters.

### (2) DESCRIPTION OF THE PRIOR ART

An isolated power converter translates power from input terminals to power at output terminals with a degree of input-to-output isolation that can be measured in terms of capacitance and resistance. FIG. 1 shows an example of such a device. Many isolated power conversion circuits use magnetic coupling to provide the isolation between input terminals and output terminals. The common name for a magnetic coupling device is a power transformer 10, with a key characteristic of the power transformer being its turns-ratio, the ratio of transformer turns at the input winding to transformer turns at the output winding. Alternative names applied to input and output windings are primary and secondary windings. The turns ratio is commonly described by two integer values, shown as variables M:N below the transformer.

The power transformer relies on alternating magnetic fields to couple power from the input to the output and, therefore, the power conversion circuits have either AC inputs or switching to produce an AC signal from a DC input. Conversion from DC inputs to AC for the transformer and any other AC or DC input conditioning occurs in block 11.

Block 12 contains any output power conditioning necessary including, for example, AC-to-DC conversion that would be needed for a DC output.

In an ideal isolated power converter, only differential currents flow at input terminals and at output terminals. Common mode noise currents are defined as AC currents that flow across the isolation common to input and output terminals. They are undesirable for several reasons including electromagnetic interference (EMI).

Common mode noise currents result from parasitic capacitance across the isolation barrier within the power conversion circuit. Parasitic capacitance between the input power conditioning circuit 11, and output power conditioning circuit 12, can be controlled by circuit layout. Parasitic capacitance between the windings of the transformer is more problematic because close proximity is needed for magnetic coupling. If the electrostatic coupling is not balanced perfectly, a common mode noise current will flow.

A common circuit arrangement to reduce common mode noise currents is the common mode current filter shown in FIG. 2. The addition of an EMI plane, 13, and capacitors 14 very close to the power converter input and output will provide a low impedance path for common mode currents to return to their source. The primary drawback to this approach is the increased capacitance between transformer input and output. This approach reduces the isolation impedance at high frequency.

Also shown in FIG. 2 is the addition of a common mode choke 15. This component is added to increase common mode impedance to improve isolation and also to further reduce common mode currents. Isolation is improved for frequencies above the resonant frequency produced by the total effective isolation capacitance and common mode choke inductance. Below this frequency, the isolation capacitance is still increased relative to the original transformer.

Another approach (not shown) places a common mode choke at the output terminals of isolated power conversion circuits. This is placed in addition or instead of the input side common mode choke. The addition of a second common mode choke will increase the effective common mode choke inductance but the isolation capacitance is still increased relative to the original transformer at frequencies below the resonant frequency.

Additional components (not shown) can be found in design literature including ferrite beads and differential noise reduction devices together creating a class of circuitry known as a common mode or EMI filters (U.S. Pat. Nos. 6,788,558, 6,898,092, 6,927,665, Tyco filter data sheet, Synqor application note, Curatolo & Cogger). Generally, these methods manipulate common mode and differential mode impedance and result in lower common mode current at the expense of power converter isolation. Power converter isolation is generally reduced by the increased component count across the isolation barrier required to implement the EMI filter.

Another approach uses active circuitry to produce offset currents to cancel common mode current (U.S. Pat. Nos. 6,490,181, 6,636,107, 6,794,929, 6,842,069 and 6,879,500). Generally, these methods result in lower common mode current at the expense of reduced power converter isolation due to increased component count across the isolation barrier.

Another approach describes transformer layout to reduce common mode current generation within transformers (U.S. Pat. Nos. 5,990,776, 6,980,074 and 7,292,126). Generally, these methods result in converter isolation that is limited by transformer primary to secondary coupling capacitance which is directly related to the smaller of the transformer turns ratio integers (N:M in FIG. 1).

Another approach utilizes noise filter packaging optimization design (U.S. Pat. Nos. 7,038,899 and 7,078,988) to make incremental improvement to converter isolation impedance relative to the general class of EMI filtering circuits.

Power conversion for motor drive circuits is an application area where relevant common-mode filtering methods are applied to DC-to-three-phase-AC power conversion (U.S. Pat. Nos. 6,208,098, 6,377,479 and 6,583,682).

### BRIEF SUMMARY OF THE INVENTION

Therefore, an object of the invention is to provide a reduction in common mode currents and EMI without a reduction in isolation impedance and in many cases with an improved isolation barrier.

The first aspect of the invention is separating the desired N:M power transformer into two power transformers, the first 16, having a turns ratio of N:1 and the second 17, having a turns ratio of 1:M. The one turn secondary of the first transformer and the one turn primary of the second transformer each achieve the lowest possible capacitive coupling to their respective primary and secondary windings. Without

Accordingly, a second aspect of the invention is the addition of common mode filtering components, a common mode choke 15, EMI plane 13 and capacitors 14, around the input side conditioning circuits 11 and first transformer 16. The common mode choke can be located either at the power input or within the 1 turn loop provided by the splitting of transformer described above. The EMI filter capacitors reduce the isolation performance of the input side (N: 1) transformer but do not affect the output side transformer 17.

### BRIEF DESCRIPTION OF THE DRAWINGS

FIG. 1 is a block diagram view of the general isolated power conversion circuit without any identifiable components for common mode noise current suppression.

FIG. 2 shows a schematic of prior art with respect to common mode noise current filtering.

FIG. 3 shows a schematic of an embodiment of the invention.

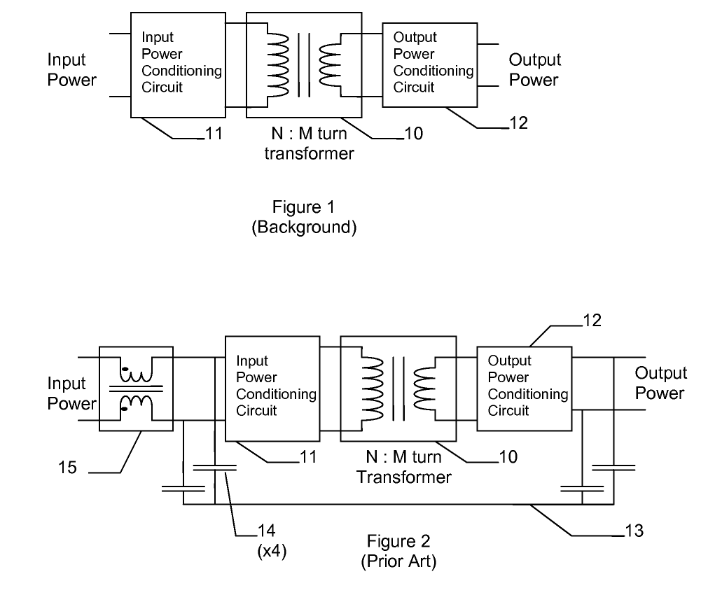

### DETAILED DESCRIPTION OF THE INVENTION

Common mode current noise filtering is a recognized as an essential element of compliance with regulatory requirements of electronic equipment. Filters similar in design to the prior art shown in FIG. 2 are especially common in systems containing isolated dc-dc power conversion circuits.

There are isolated power conversion applications, however, that can not tolerate the decrease in low frequency isolation inherent with these filters. The object of the present invention is to provide exceptional common mode current noise filtering and

In relation to the prior art of FIG. 2, and in accordance with the present invention, a nominal isolation transformer 10 is separated into two transformers which would perform similar power conversion function, taking additional losses, if any, into account, if connected in series. In transformer terms, replacing an N:M turns ratio nominal transformer would require a N:1 turns ratio transformer and a 1:M turns ratio transformer. This arrangement enables the placement of nominal common mode current noise filtering components between the series connection. As a result, the effective impedance across the series of components is increased and common mode current is decreased relative to the nominal transformer alone.

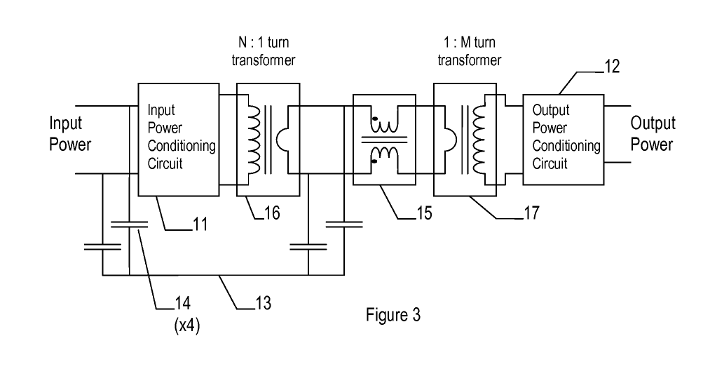

FIG. 3 illustrates an embodiment of the common mode current noise reduction method according to the invention in a power conversion circuit. Electrical power is applied to the input terminals at the power input side of the circuit. The input power conditioning Circuit 11 makes any adjustments necessary, for example switching, to properly power the primary side of the first power transformer 16. The secondary side of the first power transformer has a single turn and therefore produces the lowest switching voltage possible. Traditional common mode current filtering components and circuits 13, 14, 15, adjusted for the secondary side design of the first transformer, are applied at this point. The common mode current noise filtering will reduce the isolation of first transformer.

The filtered power signal can now be applied to the primary side of the second transformer 17. A one turn primary provides equal or higher isolation impedance than would have been achieved from the nominal isolation transformer (FIG. 2, 10). The secondary of the second transformer and output power conditioning 12 are consistent with the prior art of FIG. 2.

Many alternative embodiments and variations on the teachings disclosed herein are possible, as is understood by and is apparent to one of ordinary skill in the art. Such embodiments having different specific forms, structures arrangements, proportions and with other elements and components do not depart from the spirit or essential characteristics of the present invention. Therefore, the embodiment described herein being illustrative and not restrictive, such alternative embodiments and variations are intended to be included within the scope of the claims that follow this description and without the claims being limited by the foregoing description.

What is claimed is:

1. A common mode current noise reducing method for the reduction of common mode current noise in an isolated power conversion circuit comprising two or more input terminals for power input, and two or more output terminals for power output, the common mode current noise reducing method comprising:
a first transformer with a variable, N, number turns on a primary side and a single turn on a secondary side; and
a second transformer having a single turn on a primary side and a variable number, M, turns on a secondary side, whereby the effective turns ratio of a series connected pair of said first and second transformers would be N:M; and
a common mode current filter connected around the first transformer circuitry for the purpose of reducing the common mode currents flowing into the second transformer, said common mode current filter comprising two or more components between the secondary leads of the first transformer for the purpose of creating an EMI plane below the transformer and one or more additional components connected between said EMI plane and terminals at the input or internal to the input power conditioning circuit.

2. The common mode current noise reducing method of claim 1 wherein the common mode current filter components for creating an EMI plane are two matched capacitors.

3. The common mode current noise reducing method of claim 1 and claim 2 wherein the common mode current filter further comprising a common mode choke between the secondary of the first transformer and the primary of the second transformer.

4. The common mode current noise reducing method of claim 1 and claim 2 wherein the common mode current filter further comprising a common mode choke between the input power conditioning circuit and the primary of the first transformer.

5. The common mode current noise reducing method of claim 1 and claim 2 wherein the common mode current filter further comprising one or more ferrite beads on the conductors in the circuitry between the secondary side of the first transformer and the primary side of the second transformer.

6. The common mode current noise reducing method of claim 1 and claim 2 wherein the common mode current filter further comprising one or more ferrite beads on the conductors in the circuitry between the input power conditioning circuit and the primary side of the first transformer.
